(19) United States
(12) Patent Application Publication
(10) Pub. No.: US 2026/0079744 A1
(43) Pub. Date: Mar. 19, 2026

(54) RETURNING A CONTENTION INDICATOR WITH A FETCH REQUEST TO ALLOW AN INTERRUPTED OPERATION TO COMPLETE

(71) Applicant: INTERNATIONAL BUSINESS MACHINES CORPORATION, ARMONK, NY (US)

(72) Inventors: Ashraf ElSharif, Austin, TX (US); Jason D. Kohl, Austin, TX (US); Gregory William Alexander, Pflugerville, TX (US)

(21) Appl. No.: 18/888,069

(22) Filed: Sep. 17, 2024

(51) Int. Cl. G06F 9/48; G06F 9/30

(52) U.S. Cl. CPC G06F 9/485; G06F 9/30047

(57) ABSTRACT

Provided are a computer implemented method, system, and computer program product for returning a contention indicator with a fetch request to allow an interrupted operation to complete. A first processor core performs an operation on a cache line. The processor core aborts the operation on the cache line in response to a fetch request for the cache line from a second processor core. The first processor core transmits a response to the fetch request including a contention indicator to cause delay of submission of an additional fetch request for the cache line.

### BACKGROUND OF THE INVENTION

### 1. Field of the Invention

The present invention relates to a computer implemented method, system, and computer program product for returning a contention indicator with a fetch request to allow an interrupted operation to complete.

### 2. Description of the Related Art

A processor chip may have multiple cores having hardware, such as L1 and L2 caches, and a shared cache memory, such as L3 and greater cache memories. During processor core operations, fetch requests for a cache line from a requesting processor core may interrupt the operations being performed at a processor core currently operating on the cache line by fetching away the operated on cache line. This will cause the interrupted processor core to re-request the cache line from the processor core currently having the cache line to complete the interrupted operation. However, the interrupted processor core after re-obtaining the cache line to complete the interrupted operation may again be interrupted from a fetch request from another processor core for that same cache line, further delaying completing the operation. This contention conflict with continual interrupts to the processor core may prevent the interrupted processor core from timely completing the interrupted operation requiring the cache line.

### SUMMARY

Provided are a computer implemented method, system, and computer program product for returning a contention indicator with a fetch request to allow an interrupted operation to complete. A first processor core performs an operation on a cache line. The processor core aborts the operation on the cache line in response to a fetch request for the cache line from a second processor core. The first processor core transmits a response to the fetch request including a contention indicator to cause delay of submission of an additional fetch request for the cache line.

### BRIEF DESCRIPTION OF THE DRAWINGS

FIG. 1 illustrates an embodiment of a computing environment.

FIG. 2 illustrates an embodiment of L2 cache and the L2 cache controller.

FIG. 3 illustrates an embodiment of a contention indicator returned by a processor core in response to a fetch request for a cache line that interrupts a current operation performed by the processor core using the cache line.

FIG. 4 illustrates an embodiment of a local fetch contention indicator maintained by local fetch logic including information from the contention indicator returned by the processor core.

FIG. 5 illustrates an embodiment of a remote fetch contention indicator maintained by remote fetch logic including information from the contention indicator returned by the processor core.

FIG. 6 illustrates an embodiment of operations performed by a processor core to respond to a fetch request that interrupts an operation at the processor core.

FIG. 7 illustrates an embodiment of operations performed by local fetch logic of a cache controller for the L2 cache to process a cache line returned to a fetch request with a contention indicator.

FIG. 8 illustrates an embodiment of operations to process a fetch request for a cache line from a remote processor core.

FIG. 9 illustrates an embodiment of operations to process a fetch request from an attached core for a cache line in a remote core.

FIG. 10 illustrates a computing environment in which the components of FIG. 1 may be implemented.

### DETAILED DESCRIPTION

Described embodiments provide improvements to computer technology for managing contention issues caused by a hardware fetch request for a cache line interrupting a processor core performing an operation with respect to the requested cache line. Described embodiments have the interrupted processor core return a contention indicator along with the cache line to the fetch request. The contention indicator may include a delay time hint. This contention indicator is used at the requesting processor core or any other processor core that retrieves the cache line from a processor core to initiate a timer for the delay time hint that delays requests to the cache line during the duration of the timer to allow the interrupted processor to re-acquire the cache line and complete the interrupted operation, which may comprise an atomic operation. After the timer expires, fetch requests for the cache line may proceed.

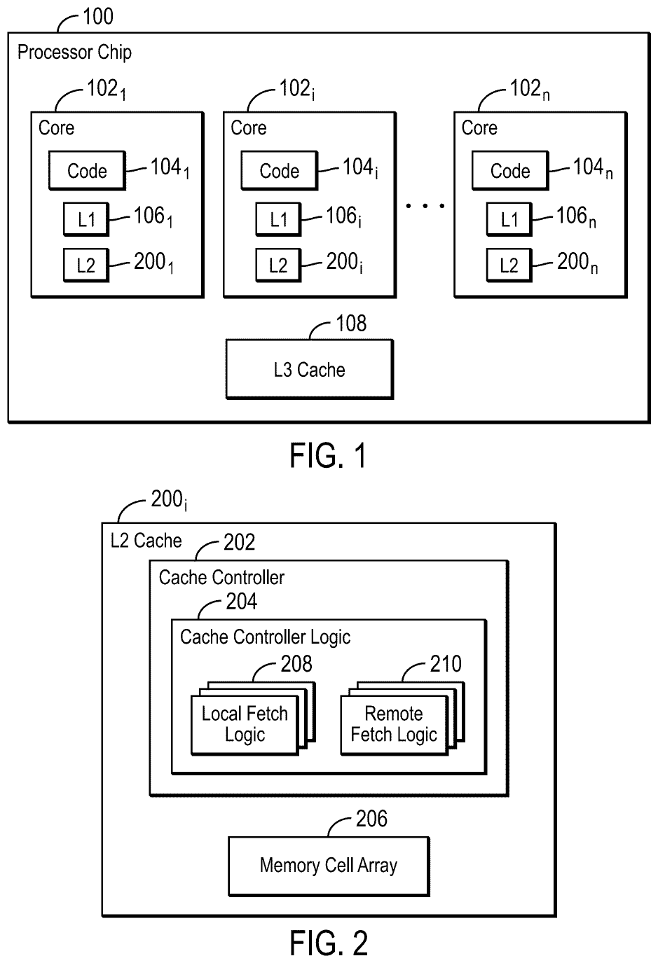

FIG. 1 illustrates an embodiment of a processor chip 100, in which embodiments may be implemented, including a plurality of processing cores 102₁, 102ᵢ . . . 102ₙ. Each core 102₁, 102ᵢ . . . 102ₙ has core code 104₁, 104ᵢ . . . 104ₙ, such as an instruction set executed by the core 102ᵢ, an on-chip L1 cache 106₁, 106ᵢ . . . 106ₙ and on-chip L2 cache 200₁, 200ᵢ . . . 200ₙ that are private to the processing cores 102₁, 102ᵢ . . . 102ₙ, respectively_{.} Alternatively, the L2 cache 200ᵢ may comprise an off-chip cache to the core 102ᵢ, yet still private to the core 102ᵢ. The processor chip 100 further includes a last level cache (LLC) 108, also known as an L3 cache, providing a larger storage space to cache data for the L1 and L2caches in the different cores 102ᵢ. There may be further levels of caches, such as an intermediate or L4 to cache data for the L3 cache 108. The L3 cache 108 may comprise Dynamic Random Access Memory (DRAM) devices. The processing cores 102₁, 102ᵢ . . . 102ₙ may write-back modified cache lines from the L2 cache 200₁, 200ᵢ . . . 200ₙ to the shared last level cache (LLC) 108, shared among the cores 102₁, 102ᵢ . . . 102ₙ, to make room for a cache line evicted from the L1 cache 106₁, 106ᵢ . . . 106ₙ. The processor cores 102ᵢ may communicate through the L3 and higher level caches.

FIG. 2 illustrates an embodiment of an L2 cache 200ᵢ as including a cache controller 202 having cache controller logic 204 to manage reading and writing data to a cache memory cell array 206. The cache controller logic 204 may implement one or more instances of local fetch logic 208 to manage fetching cache lines for the local processor core 102ᵢ held by another remote processor core 102ⱼ. The cache controller logic 204 may also implement one or more instances of remote fetch logic 210 to manage receiving from remote processor cores 102ⱼ requests for cache lines held by the local processor core 102ᵢ. In certain embodiments, the local fetch logic 208 may comprise a local fetch address register controller (LFAR) and the remote fetch logic 210 may comprise a remote fetch address register controller (RFAR).

The cache memories 106ᵢ, 108, 200ᵢ may comprise a high-speed data storage layer which stores a subset of data, typically transient in nature, so that future requests for that data are served up faster than is possible by accessing the primary storage location of the data. The cache memories 106ᵢ, 108, 200ᵢ may comprise a volatile or non-volatile memory device, such as a Static Random Access Memory (SRAM), Dynamic Random Access Memory (DRAM), eDRAM (embedded DRAM). Other embodiments may utilize phase change memory (PCM), Magnetoresistive random-access memory (MRAM), Spin Transfer Torque (STT)-MRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

The cache controller logic 204 may be implemented in circuitry in a semiconductor device, such as am Application Specific Integrated Circuit (ASIC), Field Programmable Gate Array (FPGA). Alternatively, the cache controller logic 204 may be implemented in a processor executing computer readable instructions stored in a memory.

The processor chip 100 may be included in a larger system of multiple-processor chips 100. In further embodiments, the cores 102ᵢ may be distributed across multiple processor chips and not on a single chip substrate.

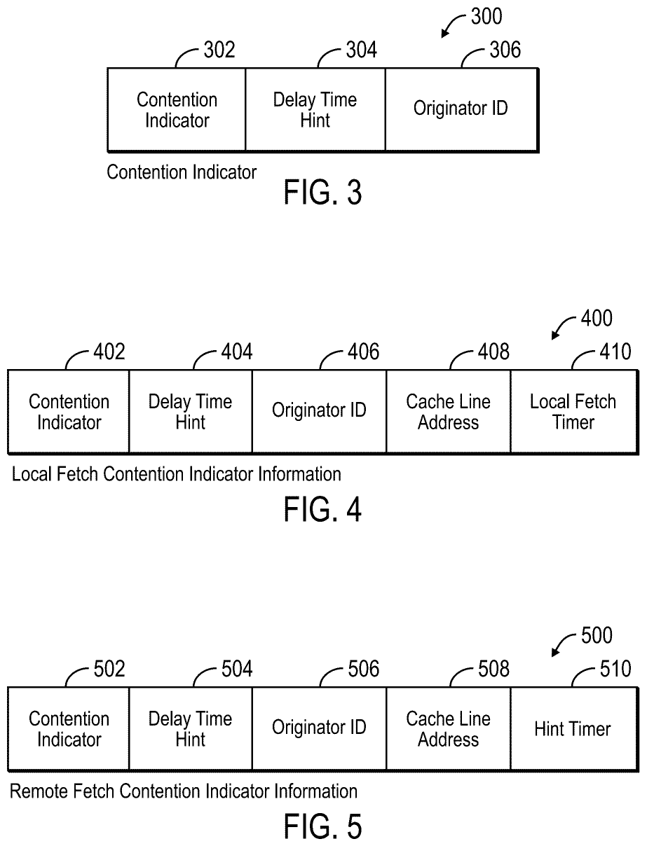

FIG. 3 illustrates an embodiment of contention indicator information 300 the processor core 102ᵢ provides when returning, in response to a fetch request, a cache line held by the processor core 102ᵢ. The contention indicator 300 indicates to the requesting processor core 102ⱼ initiating the fetch request that the fetch request interrupted an atomic operation with respect to the returned cache line. The contention indicator 300 the processor core 102ᵢ returns with the cache line may include: a contention indicator 302 field identifying the information as for a contention indicator; a delay time hint 304 indicating an estimated time the processor core 102ᵢ, from which the cache line is fetched interrupting an atomic operation, needs to complete the atomic operation with respect to the cache line; and an originator identifier (OID) 306 identifying the processor core 102ᵢ whose atomic operation was interrupted.

FIG. 4 illustrates an embodiment of contention indicator information 400 the local fetch logic 208, in a cache controller 202ⱼ for the processor core 102ⱼ initiating the fetch request, maintains when receiving the contention indicator 300 with the cache line in response to the fetch request from the processor core 102ⱼ sent to the core 102ᵢ. The contention indicator information 400 includes in fields 402, 404, and 406 the information in fields 302, 304, and 306 in the received contention indicator 300, respectively; a cache line address 408 of the cache line returned from the processor core 102ᵢ in response to the fetch request; and a local fetch timer 410 the local fetch logic 208 starts in response to receiving the contention indicator 300. The local fetch timer 410 used by the local fetch logic 208 to determine how long to extend the local fetch logic 208 may be a default value that is different from the delay time hint 304 used by the remote fetch logic 310.

In certain embodiments, the duration of the local fetch timer 410 may be typically less than the delay time hint 404.

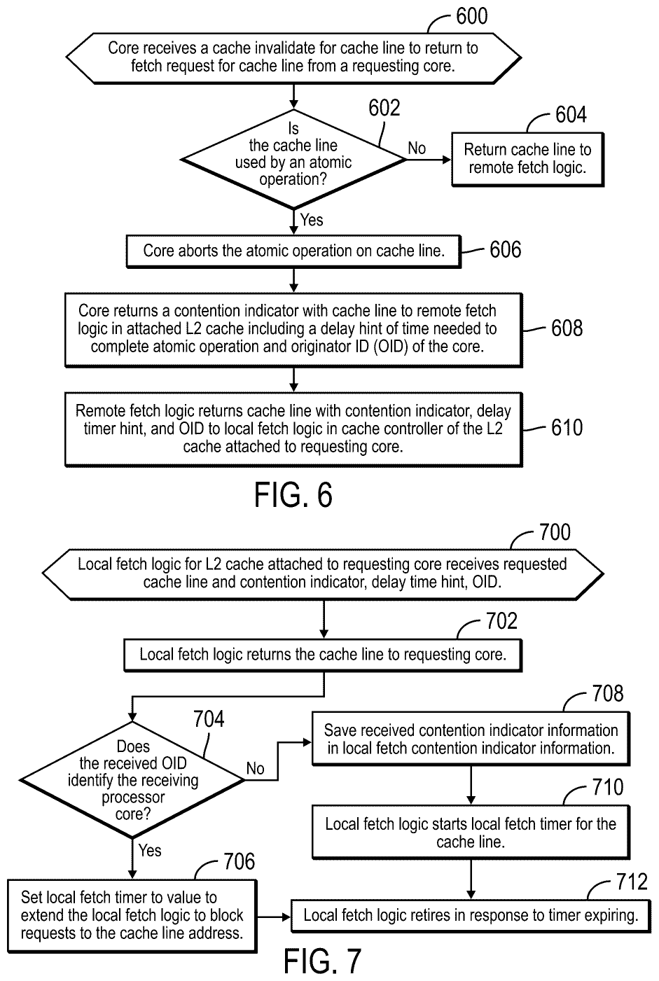

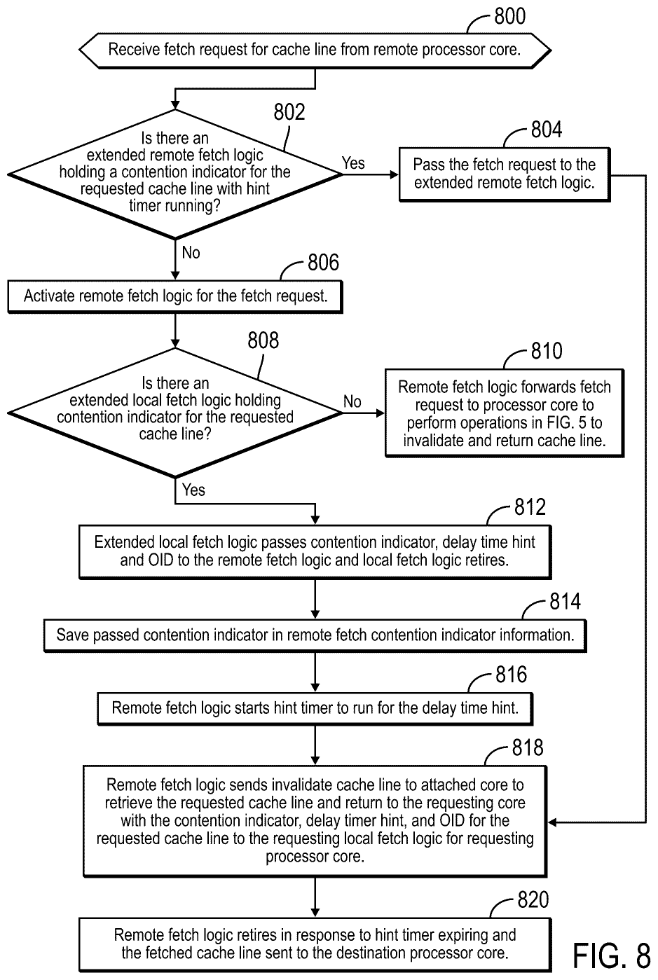

FIG. 5 illustrates an embodiment of contention indicator information 500 the remote fetch logic 210, in a cache controller 202ⱼ for the processor core 102ⱼ initiating the fetch request, maintains when receiving a fetch request from another processor core 102ₖ for the cache line indicated as the cache line 408 in local fetch contention indicator information 400. The remote fetch contention indicator information 500 includes in fields 502, 504, and 506 the information in fields 402, 404, and 406, respectively, passed from the local fetch logic 208; the cache line address 508 of the cache line returned from the processor core 102ᵢ in response to the fetch request; and a hint timer 510 set to the delay time hint 504 the remote fetch logic 210 starts in response to receiving the request from another processor core 102ₖ. The hint timer 510 is used by the remote fetch logic 210 to determine how long to extend the remote fetch logic's 210 tenure of protecting/monitoring the cache line address 508.

FIG. 6 illustrates an embodiment of operations performed by the code 104ᵢ in a processor core 102ᵢ and the cache controller logic 204 of the cache controller 202 for the processor core 102ᵢ performed in response to a fetch request. The processor core 102ᵢ receives (at block 600) a cache invalidate for a cache line to return to a fetch request for the cache line from a requesting processor core 102ⱼ. If (at block 602) the cache line used by the processor core 102ᵢ is not part of an atomic operation, the cache line is returned (at block 604) by the remote fetch logic 210 for the processor core 102ᵢ receiving the fetch request to the requesting processor core 102ⱼ without a contention indicator 300 indicting that the processor core 102ᵢ was interrupted by the fetch request. If (at block 602) the fetched cache line is used in an atomic operation, then the processor core 102ᵢ aborts (at block 606) the atomic operation on the cache line. The processor core 102ᵢ returns (at block 608) a contention indicator 300 with the cache line to remote fetch logic 210, in the cache controller 202 of the L2 cache 200ᵢ for the processor core 102ᵢ, including a delay time hint 304 of time the processor core 102ᵢ needs to complete the atomic operation and originator ID (OID) 306 of the core 102ᵢ. The delay time hint 304 may be determined from metrics gathered from previous runs of the atomic operation at the processor core 102ᵢ or from predetermined delay time hints provided for atomic operation. The remote fetch logic 210, in the cache controller 202 of the L2 cache 200ᵢ for the processor core 102ᵢ, returns (at block 610) the cache line with the contention indicator 300 to the local fetch logic 208 in the cache controller 202 of the L2 cache attached to the requesting processor core 102ⱼ to return to the core 102ⱼ.

With the embodiment of operations of FIG. 6, when a processor core 102ᵢ has to abort an atomic operation to return a cache line to a requesting processor core 102ⱼ, the interrupted processor core 102ᵢ provides a contention indicator 300 that is used by the interrupting processor core 102ⱼ and other cores taking the cache line to cause them to delay submitting a subsequent request for the cache line to provide the interrupted processor core 102ᵢ time to reacquire the cache line to complete the interrupted atomic operation.

FIG. 7 illustrates an embodiment of operations performed by local fetch logic 208 to process a fetched cache line returned with a contention indicator 300 from the interrupted processor core 102ᵢ. Upon the local fetch logic 208, for the L2 cache 200ⱼ attached to the requesting processor core 102ⱼ, receiving (at block 700) the requested cache line and the contention indicator 300, including delay time hint 304 and originator ID 306, the local fetch logic 208 returns (at block 702) the cache line to the requesting core 102ⱼ. If (at block 704) the received OID 306 identifies the receiving processor core 102ⱼ, i.e., the interrupted processor core 102ᵢ, then the local fetch logic 208 may set (at block 706) the local fetch timer 410 to a default value or the delay time hint 404 to extend the local fetch logic 208 to block the remote fetch logic 210 of another processor core 102ⱼ from fetching away the cache line address 408 without passing the contention indicator 300 to the remote fetch logic 210. If (at block 704) the received OID 306 does not identify the receiving processor core 102ⱼ, i.e., is not the interrupted processor core, then the local fetch logic 208 saves (at block 708) the received contention indicator 300 information as the local fetch contention indicator information 400 and starts (at block 710) a local fetch timer 410, which may be a default timer and not the delay time hint 404. From block 706 or 710, the local fetch logic 208 retires (at block 712) in response to the local fetch timer 410 expiring.

With the embodiment of operations of FIG. 7, the local fetch timer 410 extends the local fetch logic 208 to monitor for fetch requests to the cache line to ensure that the interrupted processor core will have sufficient time to complete the aborted atomic operation.

FIG. 8 illustrates an embodiment of operations performed by the cache controller logic 204 in the processor core 102ᵢ in response to receiving a fetch request from a remote processor core 102ⱼ. Upon a processor core 102ᵢ receiving (at block 800) a fetch request from a remote processor core 102ⱼ, if (at block 802) there is an extended remote fetch logic 210 holding a contention indicator 500 whose cache line address 508 matches the requested cache line with the hint timer 510 running, then the fetch request is passed (at block 804) to the extended remote fetch logic 210 of the processor core 102ᵢ. If (at block 802) there is no extended remote fetch logic 210 holding a contention indicator 500 having a cache line address 508 matching the requested cache line at processor core 102ᵢ, then remote fetch logic 210 is activated (at block 806) in the processor core 102ᵢ for the fetch request. If (at block 808) there is no extended local fetch logic 208 holding a contention indicator 400 for the requested cache line, then the remote fetch logic 210 forwards (at block 810) the fetch request to the processor core 102ᵢ to perform the operations in FIG. 5 to invalidate and return the requested cache line. If (at block 808) there is an extended local fetch logic 208 at the processor core 102ᵢ holding the contention indicator 400 for the requested cache line, then the extended local fetch logic 208 passes (at block 812) the contention indicator 400, delay time hint 504, and OID 506 to the remote fetch logic 210 and the local fetch logic 208 of the processor core 102ᵢ retires. The remote fetch logic 210 saves (at block 814) the passed contention indicator information 400 in remote fetch contention indicator information 500.

The remote fetch logic 210 starts (at block 816) the hint timer 510 to run for the delay time hint 504. From block 804 or block 816, control proceeds to the remote fetch logic 210 sending (at block 818) the invalidate cache line to the attached core 102ᵢ to retrieve the requested cache line and return to the requesting core 102ⱼ. The remote fetch logic 210 retires (at block 820) in response to the hint timer 510 expiring and the fetched cache line sent to the destination processor 200ⱼ.

With the embodiment of FIG. 8, remote fetch logic 210 is started to maintain a contention indicator 500 for a cache line 508 and forward the contention indicator 500 to the cache controller 202 of the L2 cache 200ⱼ of the requesting core 102ⱼ to have the requesting core 102ⱼ delay requests to retrieve the cache line. This delay provides time for the original interrupted processor core 506 to re-fetch the cache line and complete the interrupted atomic operation.

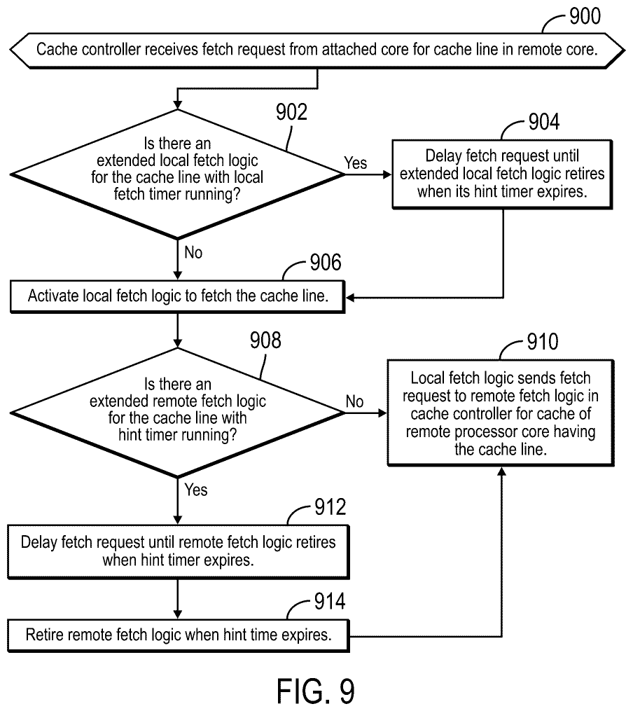

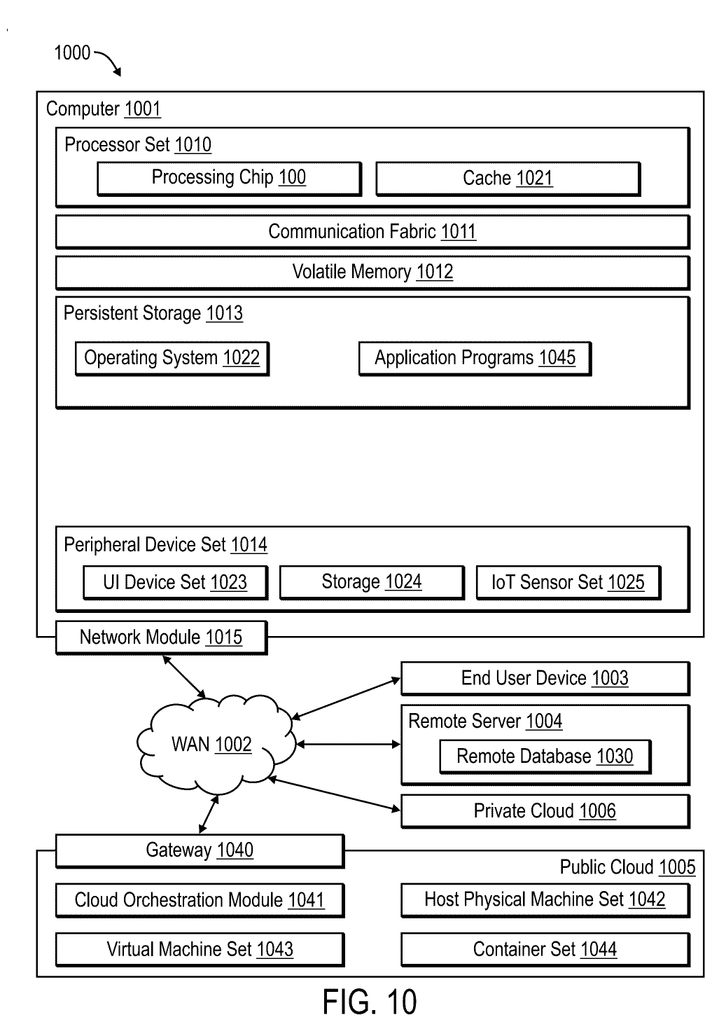

FIG. 9 illustrates an embodiment of operations performed by the cache controller logic 204 to process a fetch request from a local processor core 102ᵢ for a cache line at a remote processor core 102ⱼ. Upon receiving (at block 900) the fetch request, if (at block 902) there is extended local fetch logic 208 for the requested cache line with the local fetch timer 410 running, then the fetch request is delayed (at block 904) until the extended local fetch logic 208 retires. If (at block 902) there is no extended local fetch logic 208 for the requested cache line (from the NO branch of block 902) or after delaying (at block 904) the fetch request until the local fetch logic 208 retires, local fetch logic 208 is activated (at block 906), which is not associated with a contention indicator, to fetch the requested cache line. If (at block 908) there is no extended remote fetch logic 210 for the cache line with the hint timer 510 running, then the local fetch logic 208 sends (at block 910) the fetch request to the remote fetch logic 210 in the cache controller 202 for the cache 200ⱼ of the processor core 102ⱼ having the requested cache line. If (at block 908) there is extended remote fetch logic 210 holding a contention indicator 508 for the requested cache line, the fetch request is delayed (at block 912) until the remote fetch logic retires 210, which occurs when the hint timer 510 expires. The remote fetch logic 210 is retired (at block 914) when the hint timer 510 expires and control proceeds to block 910 to send the fetch request to the remote processor core 102ⱼ to fetch.

With the embodiment of FIG. 9, a fetch request from a processor core 102ᵢ is delayed if there is extended local fetch logic 208 or remote fetch logic 210 for the requested cache line holding the contention indicator 400, 500 for the requested cache line to delay the fetch request to provide the initially interrupted processor core, identified in fields 306, 406, 506, with time to complete the aborted operation using the requested cache line that was interrupted when the cache line it was operating was fetched away.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With respect to FIG. 10, computing environment 1000 contains an example of an environment in which the processor chip 100 may be implemented. Computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including one or more processor chips 100 (FIG. 1) and a cache 1021, which may comprise a higher level cache having data shared among the cores in one or more processor chips 100), communication fabric 1011, volatile memory 1012, persistent storage 1013 (including operating system 1022 and application programs 1045), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, processor chips 100 such as described above. The processors of any type now known or to be developed in the future. The components on the processor chip 100 may be may be distributed over multiple packages, for example, multiple, coordinated integrated circuit chips. The processing chip 100 may implement multiple processor threads and/or multiple processor cores.

Cache 1021 is memory that is located in the processor chip package(s) and is typically used for data or code that should be available for rapid access by the threads or cores running on processor set 1010. The cache 102 may comprise cache memories L1 106ᵢ, L2200ᵢ, and L3 cache 108 on the processor chip 100. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be implemented in the core 102ᵢ code 104ᵢ and cache controller logic 204.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices.

Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Cloud COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, j, k, and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for managing cache lines in caches for processor cores, comprising:
performing, by a first processor core, an operation on a cache line;
aborting, by the first processor core, the operation on the cache line in response to a fetch request for the cache line from a second processor core; and
transmitting, by the first processor core, a response to the fetch request including a contention indicator to cause delay of submission of an additional fetch request for the cache line.

2. The computer implemented method of claim 1, wherein the contention indictor is only included in the response to the fetch request returned to the second processor core in response to the operation on the cache line at the first processor core comprising an atomic operation.

3. The computer implemented method of claim 1, further comprising:
forwarding, by a first cache controller of a first cache for the first processor core, the cache line and the contention indicator to a second cache controller of a second cache for the second processor core, wherein the contention indicator includes a delay time; and
initiating, by the second cache controller, a timer for a duration of the delay time in response to receiving a request for the cache line in the second processor core, wherein during the duration of the timer the additional fetch request from the second processor core for the cache line is delayed until the timer expires.

4. The computer implemented method of claim 3, wherein the fetch request comprises a first fetch request, wherein the timer comprises a first timer, further comprising:
receiving, at the second cache controller, a second fetch request, from a third cache controller of a third cache for a third processor core, for the cache line at the second processor core during the duration of the first timer at the second cache controller;
returning, by the second cache controller, the cache line and the contention indicator with the delay time to the third cache controller; and
initiating, by the third cache controller, a second timer for the duration of the delay time to delay the third processor core from submitting the additional fetch request for the cache line during the duration of the second timer.

5. The computer implemented method of claim 3, wherein the fetch request comprises a first fetch request, wherein the contention indicator from the first cache controller further includes an originator identifier of the first processor core, further comprising:
submitting, by the first processor core, a second fetch request to the second cache controller for the cache line in the second processor core;
returning, by the second cache controller, for the second fetch request, the cache line in the second processor core and the contention indicator, including the delay time and the originator identifier, to the first cache controller in response to receiving the second fetch request during the duration of the timer;
setting, by the first cache controller, a timer to extend monitoring for the cache line at the first processor core in response to determining that the originator identifier identifies the first processor core; and
forwarding the cache line for the second fetch request to the first processor core.

6. The computer implemented method of claim 1, further comprising:
forwarding, by a first cache controller of a first cache for the first processor core, the cache line and the contention indicator to a second cache controller of a second cache for the second processor core;
forwarding, by local fetch logic in the second cache controller, the cache line to the second processor core;
initiating, by the local fetch logic in the second cache controller, a timer to extend the local fetch logic in the second cache controller during a duration of the timer; and
delaying, by the local fetch logic in the second cache controller, the additional fetch request from the second processor core for the cache line during the duration of the timer.

7. The computer implemented method of claim 1, wherein the contention indicator includes a delay time, further comprising:
forwarding, by a first cache controller of a first cache for the first processor core, the cache line and the contention indicator to a second cache controller of a second cache for the second processor core;
maintaining, by local fetch logic in the second cache controller, the contention indicator from the first processor core;
receiving, at the second cache controller, a second fetch request, from a third cache controller for a third cache of a third processor core, for the cache line at the second processor core;
passing, by the local fetch logic in the second cache controller, the contention indicator and the delay time to remote fetch logic in the second cache controller;
initiating, by the remote fetch logic in the second cache controller, a remote fetch timer for the delay time in the contention indicator to extend the remote fetch logic; and
transmitting, by the remote fetch logic in the second cache controller, the cache line at the second processor core and the contention indicator to the third cache controller.

8. The computer implemented method of claim 7, further comprising:
retiring the local fetch logic at the second cache controller in response to one of a local fetch timer expiring and passing the contention indicator to the remote fetch logic in the second cache controller; and
retiring the remote fetch logic at the second cache controller in response to the remote fetch timer expiring and the cache line sent to the third cache controller.

9. The computer implemented method of claim 7, further comprising:
receiving, at the second cache controller, a third fetch request from the second processor core for the cache line at the first processor core; and
delaying, by the second cache controller, submitting the third fetch request to the first processor core for a duration of the remote fetch timer.

10. A system for managing cache lines in caches for processor cores, comprising:
a first processor core;
a second processor core,
wherein the first processor core performs operations, the operations comprising:
performing an operation on a cache line;
aborting the operation on the cache line in response to a fetch request for the cache line from a second processor core; and
transmitting a response to the fetch request including a contention indicator to cause delay of submission of an additional fetch request for the cache line.

11. The system of claim 10, wherein the contention indictor is only included in the response to the fetch request returned to the second processor core in response to the operation on the cache line at the first processor core comprising an atomic operation.

12. The system of claim 10, further comprising:
a first cache for the first processor core;
a first cache controller of the first cache;
a second cache for the second processor core;
a second cache controller of the second cache;
cache controller logic executed by the first cache controller and the second cache controller to perform operations, the operations comprising:
forwarding, by the first cache controller, the cache line and the contention indicator to the second cache controller, wherein the contention indicator includes a delay time; and
initiating, by the second cache controller, a timer for a duration of the delay time in response to receiving a request for the cache line in the second processor core, wherein during the duration of the timer the additional fetch request from the second processor core for the cache line is delayed until the timer expires.

13. The system of claim 10, further comprising:
a first cache for the first processor core;
a first cache controller of the first cache;
a second cache for the second processor core;
a second cache controller of the second cache;
cache controller logic executed by the first cache controller and the second cache controller to perform operations, the operations comprising:
forwarding, by the first cache controller, the cache line and the contention indicator to the second cache controller;
forwarding, by local fetch logic in the second cache controller, the cache line to the second processor core;
initiating, by the local fetch logic in the second cache controller, a timer to extend the local fetch logic in the second cache controller during a duration of the timer; and
delaying, by the local fetch logic in the second cache controller, the additional fetch request from the second processor core for the cache line during the duration of the timer.

14. The system of claim 10, further comprising:
a first cache for the first processor core;
a first cache controller of the first cache;
a second cache for the second processor core;
a second cache controller of the second cache;
local fetch logic in the second cache controller;
remote fetch logic in the second cache controller;
cache controller logic executed by the first cache controller and the second cache controller, the operations comprising:
forwarding, by the first cache controller, the cache line and the contention indicator to the second cache controller;
maintaining, by local fetch logic in the second cache controller, the contention indicator from the first processor core;
receiving, at the second cache controller, a second fetch request, from the third cache controller, for the cache line at the second processor core;
passing, by the local fetch logic in the second cache controller, the contention indicator and the delay time to the remote fetch logic in the second cache controller;
initiating, by the remote fetch logic in the second cache controller, a remote fetch timer for the delay time in the contention indicator to extend the remote fetch logic; and
transmitting, by the remote fetch logic in the second cache controller, the cache line at the second processor core and the contention indicator to the third cache controller.

15. The system of claim 14, further comprising:
a third processor core;
a third cache of the third processor core;
a third cache controller for the third cache; and
wherein the cache controller logic is further executed by the third cache controller, wherein the operations further comprise:
retiring the local fetch logic at the second cache controller in response to one of a local fetch timer expiring and passing the contention indicator to the remote fetch logic in the second cache controller; and
retiring the remote fetch logic at the second cache controller in response to the remote fetch timer expiring and the cache line sent to the third cache controller.

16. A computer program product for managing cache lines in caches for processor cores, comprising a computer readable storage medium including program instructions that when executed by the processor cores perform operations, the operations comprising:
performing, by a first processor core, an operation on a cache line;
aborting, by the first processor core, the operation on the cache line in response to a fetch request for the cache line from a second processor core; and
transmitting, by the first processor core, a response to the fetch request including a contention indicator to cause delay of submission of an additional fetch request for the cache line.

17. The computer program product of claim 16, wherein the contention indictor is only included in the response to the fetch request returned to the second processor core in response to the operation on the cache line at the first processor core comprising an atomic operation.

18. The computer program product of claim 16, wherein the program instructions executed by the processor cores comprise processor core program, wherein the computer readable storage media further includes cache controller logic that when executed by cache controllers further perform operations, the operations comprising:
forwarding, by a first cache controller of a first cache for the first processor core, the cache line and the contention indicator to a second cache controller of a second cache for the second processor core, wherein the contention indicator includes a delay time; and
initiating, by the second cache controller, a timer for a duration of the delay time in response to receiving a request for the cache line in the second processor core, wherein during the duration of the timer the additional fetch request from the second processor core for the cache line is delayed until the timer expires.

19. The computer program product of claim 16, wherein the program instructions executed by the processor cores comprise processor core program, wherein the computer readable storage media further includes cache controller logic that when executed by cache controllers further perform operations, the operations comprising:
forwarding, by a first cache controller of a first cache for the first processor core, the cache line and the contention indicator to a second cache controller of a second cache for the second processor core;
forwarding, by local fetch logic in the second cache controller, the cache line to the second processor core;
initiating, by the local fetch logic in the second cache controller, a timer to extend the local fetch logic in the second cache controller during a duration of the timer; and
delaying, by the local fetch logic in the second cache controller, the additional fetch request from the second processor core for the cache line during the duration of the timer.

20. The computer program product of claim 16, wherein the contention indicator includes a delay time, wherein the program instructions executed by the processor cores comprise processor core program, wherein the computer readable storage media further includes cache controller logic that when executed by cache controllers further perform operations, the operations comprising:
forwarding, by a first cache controller of a first cache for the first processor core, the cache line and the contention indicator to a second cache controller of a second cache for the second processor core;
maintaining, by local fetch logic in the second cache controller, the contention indicator from the first processor core;
receiving, at the second cache controller, a second fetch request, from a third cache controller for a third cache of a third processor core, for the cache line at the second processor core;
passing, by the local fetch logic in the second cache controller, the contention indicator and the delay time to remote fetch logic in the second cache controller;
initiating, by the remote fetch logic in the second cache controller, a remote fetch timer for the delay time in the contention indicator to extend the remote fetch logic; and
transmitting, by the remote fetch logic in the second cache controller, the cache line at the second processor core and the contention indicator to the third cache controller.
